(19) United States
(12) Patent Application Publication
(10) Pub. No.: US 2012/0154604 A1
(43) Pub. Date: Jun. 21, 2012

(54) CAMERA RECALIBRATION SYSTEM AND THE METHOD THEREOF

(75) Inventors: Jian-Ren Chen, Hsinchu County (TW); Chung-Chia Kang, Tainan City (TW); Leii H. Chang, Hsinchu County (TW); Ho-Hsin Lee, Hsinchu City (TW); Yi-Fei Luo, Hsinchu County (TW)

(73) Assignee: Industrial Technology Research Institute, Hsinchu (TW)

(21) Appl. No.: 13/242,268

(22) Filed: Sep. 23, 2011

(30) Foreign Application Priority Data
Dec. 17, 2010 (TW) 099144577

(51) Int. Cl. H04N 17/00

(52) U.S. Cl. 348/187; 348/E17.002

(57) ABSTRACT

The invention discloses a camera recalibration system and the method thereof. The camera recalibration system includes a first camera, which is to be recalibrated, for capturing image; an image processing unit comprising a storage unit for storing a first image and a second image, the second image being captured by the first camera; and a computing unit for measuring camera motion from the first image to the second image and computing calibration information corresponding to the camera motion; and a display unit for presenting the calibration information.

### TECHNICAL FIELD

The present disclosure relates to a camera recalibration system and the method thereof.

### TECHNICAL BACKGROUND

Recently, camera-based surveillance systems have become more and more popular in communities, buildings, parks, and even residences to perform security and environmental monitoring therein, so as to improve social security of daily life. Those cameras are usually disposed on building walls or fixed to utility poles on the roadside, so they are subject to be deviated, obstructed, or damaged naturally or artificially, especially the changes in the position and viewing angle thereof. Thus the cameras can't work well in the way they are supposed to do. Although most of the surveillance systems have been equipped with functions of sensor detection, the sensors can only detect power failures, signal troubles, or mechanical faults of hardware. The systems are generally unaware of whether image-capturing conditions of the cameras are deviated or obstructed in real time. It usually takes long time to retune the cameras to their original settings after the extraordinary events occur. In such cases, the images or records captured by the out-of-condition cameras may not what they are presumed, which may cause serious impacts on the applications of intelligent video analysis.

Therefore, it is in need of a system and method for recalibrating cameras in an automatic way, which can provide the system with calibration information and inform the maintenance operators to adjust and recover the out-of-condition cameras to the original working statuses. And thereby, the camera-based surveillance system can be improved with less costs of maintenance.

### TECHNICAL SUMMARY

According to one aspect of the present disclosure, one embodiment provides a camera recalibration system including: a first camera, which is to be recalibrated, for capturing image; an image processing unit comprising a storage unit for storing a first image and a second image, the second image being captured by the first camera; and a computing unit for measuring camera motion from the first image to the second image and computing calibration information corresponding to the camera motion; and a display unit for presenting the calibration information.

According to another aspect of the present disclosure, another embodiment provides a method for recalibrating a camera which is to be recalibrated, the method comprising the steps of: providing a first image; capturing a second image by using the camera; measuring a camera motion from the first image to the second image and computing calibration information corresponding to the camera motion; and presenting the calibration information in the second image.

Furthermore, the foregoing recalibration method can be embodied in a computer program product containing at least one instruction, the at least one instruction for being downloaded to a computer system to perform the recalibration method.

Also, the foregoing recalibration method can be embodied in a computer readable medium containing a computer program, the computer program performing the recalibration method after being downloaded to a computer system.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a block diagram of a camera recalibration system according to a first embodiment of the present disclosure.

FIG. 2 illustrates a first image and a second image captured by possible cameras at different time.

FIGS. 3A to 3C are schematic diagrams of a linear arrow, an arced arrow, and a scaling sign, respectively, used to indicate the prompt sign.

FIG. 4, composed of FIGS. 4A and 4B, is a flow chart of a recalibration method for a camera according to a second embodiment of the present disclosure.

FIG. 5 schematically shows the formation of feature vectors in the two images.

FIG. 6 is a flowchart of the transformation of image coordinates.

### DESCRIPTION OF THE EXEMPLARY EMBODIMENTS

For further understanding and recognizing the fulfilled functions and structural characteristics of the disclosure, several exemplary embodiments cooperating with detailed description are presented as the following.

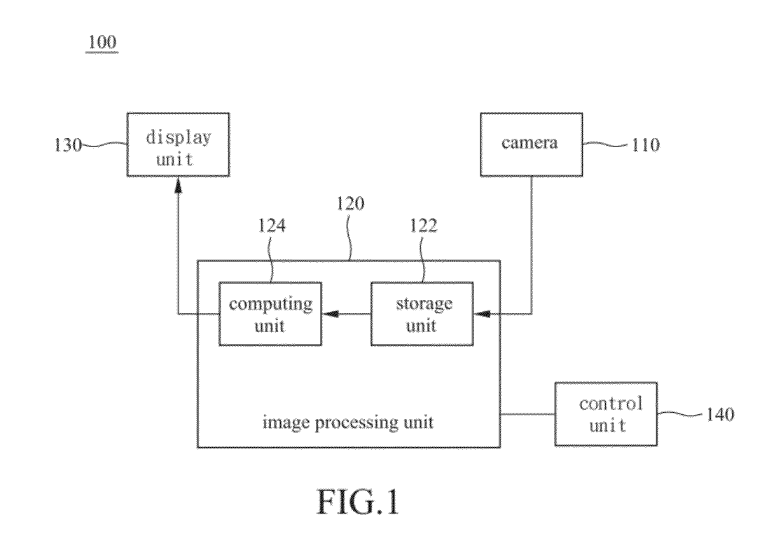

Please refer to FIG. 1, which is a block diagram of a camera recalibration system according to a first embodiment of the present disclosure. The camera recalibration system 100 includes a camera 110, an image processing unit 120 having a storage unit 122 and a computing unit 124, and a display unit 130. The camera 110 is the one to be recalibrated in the embodiment and is for capturing outside images. The to-be-recalibrated camera (hereafter, referred as “first camera”) may somehow deviate from its original FOV (field of view), such as position or view-capturing direction. Here the recalibration is to adjust the deviated camera, so that the FOV can be restored to its original FOV. The camera that has the original FOV is called original camera. The to-be-recalibrated camera can be the same as the original camera or a camera other than the original camera.

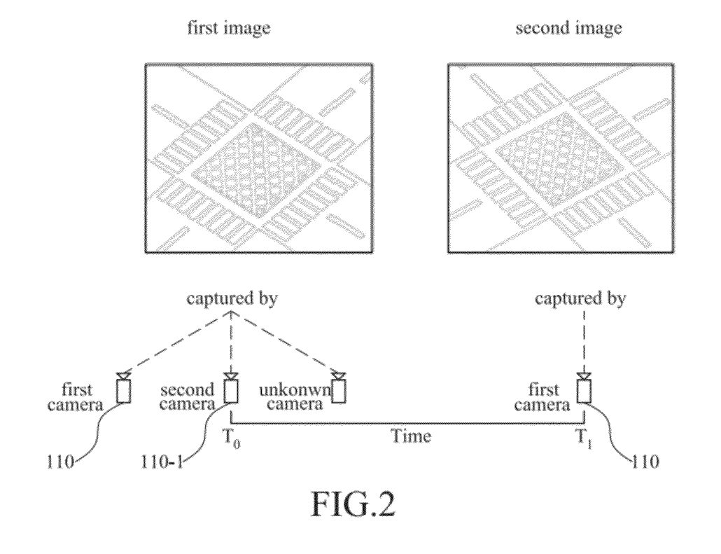

The storage unit 122 can store at least two images, which include a first image and a second image. FIG. 2 illustrates two images captured by different cameras at different time. The second image is captured by the first camera 110 at T₁, while the first image can be captured by the first camera 110 or a camera (referred as “second camera” 110-1) other than the first camera, or any unknown camera at a previous time T₀. The first image is used as the reference image for recalibration. It can be the image captured by the first camera 110 being originally set up, the image captured by the second camera 110-1 being originally set up, or the image at a predetermined location captured by any camera.

The computing unit 124 is for measuring a camera motion from the first image to the second images and computing calibration information corresponding to the camera motion. To measure the camera motion, the computing unit 124 extracts local feature points from the first and second images, and generate the matched feature points between the first image and the second image. A set of first feature vectors and a set of their paired second feature vectors are then respectively formed, wherein each first feature vector is formed by connecting a feature point to another feature point in the first image, and each second feature vector is formed by connecting the corresponding matched feature points in the second image. The camera motion containing a motion of camera roll and a scaling factor between the first and second images can hence be measured according the sets of the first and second feature vectors. Moreover, the first image can be transformed into a third image according to the motion of camera roll and the scaling factor of the second image. The camera motion containing horizontal and vertical motions can hence be measured with multiple sets of matched feature points between the third image and the second image. On the other hand, the second image can be transformed into a fourth image according to the motion of camera roll and the scaling factor of the first image. The camera motion containing horizontal and vertical motions can also be measured with multiple sets of matched feature points between the fourth image and the first image. Further, the computing unit 124 can compute calibration information which is corresponding to the camera motion measured by the computing unit 124. The camera motion may include the motions of both magnitude and direction, while the calibration information includes the calibration in both magnitude and direction corresponding to the camera motion, respectively. The calibration magnitude is equal to the motion magnitude of the camera motion, while the calibration direction is opposite to the motion direction of the camera motion.

The calibration information further includes a sign, a sound, or a frequency as a prompt and the display unit 130 presents the calibration information to the operators who perform the calibration upon the to-be-recalibrated camera. In a camera recalibration system according to an exemplary embodiment, the display unit 130 displays the second images captured by the first camera 110 in real time, and simultaneously attach the foregoing calibration information to the second images. The image processing unit 120 and/or the display unit 130 may be implemented with a PDA (personal digital assistant), an MID (mobile internet device), a smart phone, a laptop computer, or a portable multimedia device; but is not limited thereof, they can be the other type of computer or processor with a display or monitor.

The camera recalibration in the embodiment is based on the relative camera motion between the first and second images, wherein the first image is used as a reference image and the second image is an image captured by the to-be-recalibrated first camera 110. In the system 100, the camera motion can be measured with regard to the horizontal and vertical motions, the motions of camera roll (a phase angle either in clockwise or in counter-clockwise direction), and the scaling factor (either scale-up or scale-down).

The motion of camera roll can be measured by a central tendency of a data set which is composed of motion of camera yaw and camera pitch between a plurality of first feature vectors and their paired second feature vectors, wherein each first feature vector is formed by connecting a feature point to another feature point in the first image, each second feature vector is formed by connecting a feature point to another feature point in the second image, and each feature point extracted from the first image corresponds to each feature point extracted from the second image. The statistical measure of central tendency is computed from a group consisting of arithmetic mean, the median, the mode, and the histogram statistic. Therein regarding the histogram statistic, a data set is classified into multiple groups according to a predetermined value, then a histogram is formed of the statistical distribution of the groups, and finally the histogram statistic can be measured by the arithmetic mean of the bin of the highest tabular frequency and the at least one right-side and left-side nearest neighbor bins.

Similarly, the scaling factor can be measured by a central tendency of a data set which is composed of ratios of length of a plurality of the first feature vectors to their paired second feature vectors, wherein each first feature vector is formed by connecting a feature point to another feature point in the first image, each second feature vector is formed by connecting a feature point to another feature point in the second image, and each feature point extracted from the first image corresponds to each feature point extracted from the second image.

Furthermore, the first image is rotated in accordance with the motion of camera roll of the second image and scaled in accordance with the scaling factor of the second image to form a third image. The horizontal motion is measured by a central tendency of a data set which is composed of horizontal movements between feature points of the third image and their matched feature points of the second image, and the vertical motion is measured by a central tendency of a data set which is composed of vertical movements between feature points of the third image and their matched feature points of the second image. On the other hand, the second image also can be rotated in accordance with the motion of camera roll of the first image and scaled in accordance with the scaling factor of the first image to form a fourth image. The horizontal motion is measured by a central tendency of a data set which is composed of horizontal movements between feature points of the fourth image and their matched feature points of the first image, and the vertical motion is measured by a central tendency of a data set which is composed of vertical movements between feature points of the fourth image and their matched feature points of the first image.

When a camera is deviated, obstructed, or damaged naturally or artificially, the camera recalibration system 100 of the embodiment can provide maintenance operators of the system with warning signals and calibration information. Whereby, the operators may be informed to adjust and calibrate position, view angle, or direction of the camera. If the camera is deviated slightly, the system is capable of adjusting the camera automatically so as to recover its original working conditions. The computing unit 124 is provided for measuring the camera motion and computing the calibration information for the operators to perform the system's maintenance.

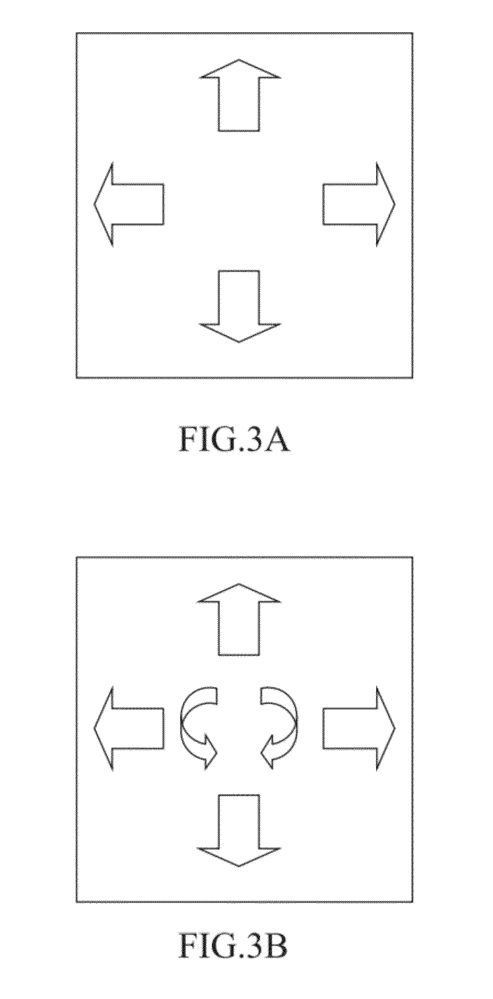

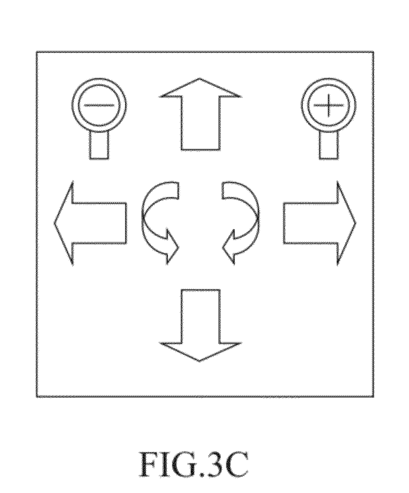

Besides the calibration magnitude and calibration direction, the calibration information may further include a sign, a sound, or a frequency as a prompt. The calibration magnitude is equal to the motion magnitude of the camera motion, while the calibration direction is opposite to the motion direction of the Camera motion. Considering the sound or the frequency, the magnitude of the sound or the frequency can be turned up or down. But regarding the prompt sign, FIGS. 3A to 3C illustrate some examples. In FIG. 3A, a linear arrow is used to indicate the prompt sign, wherein length of the linear arrow indicates the magnitude by which the first camera 110 is required to be calibrated, and arrowhead of the linear arrow indicates the direction by which the first camera 110 is required to be calibrated. In FIG. 3B, an arced arrow is used to indicate the prompt sign, wherein length of the arced arrow indicates the magnitude by which the first camera 110 is required to be calibrated, and arrowhead of the arced arrow indicates the direction by which the first camera 110 is required to be calibrated. In FIG. 3C, a scaling sign is used to indicate the prompt sign, wherein a plus sign in the icon of the scaling sign (for example, magnifying glass) indicates that the first camera 110 needs to perform a zoom-in operation, while a minus sign indicates that the first camera 110 needs to perform a zoom-out operation. In the other words, the plus sign indicates that images captured by the first camera 110 is required to be scaled up, while a minus sign indicates that images captured by the first camera 110 is required to be scaled down.

Furthermore, to equip the first camera 110 with an auto-notifying function, the camera recalibration system 100 according to the embodiment further includes a control unit 140, which is coupled to the image processing unit 120, so as to provide a warning signal when the measured camera motion of the camera 110 satisfies a predetermined condition; for example, the motion magnitude or motion direction exceeds a predetermined threshold. On the other respect, if the system 100 or the control unit 140 is set in an auto-adjustment mode and the camera motion does not exceed the predetermined threshold; for example, the motion magnitude or motion direction is less than the predetermined threshold but more than zero, the control unit 140 can perform transformation of image coordinate so as to transform the coordinate system of the image captured by the first camera 110 to that of its original setting, and hence to reduce the labor maintenance cost for the camera 110. To perform the auto-adjustment operation, the system 100 may extract feature points from the first and second images, wherein each feature point of the first image corresponds to each feature point of the second image. Then a set of first feature vectors and a set of their paired second feature vectors can be respectively formed, wherein each first feature vector is formed by connecting a feature point to another feature point in the first image, and each second feature vector is formed by connecting the corresponding matched feature points in the second image. Consequently, the camera motion such as a motion of camera roll, a scaling factor, and horizontal and vertical motions between the first and second images can be measured according the sets of the first and second feature vectors. Furthermore, the system 100 may perform coordinate transformation of the feature points between the first and second images in two ways. Firstly, coordinates of the feature points of the first image can be transformed from the coordinate system of the first image to that of the second image, according to the camera motion. Then a spatial distance between each transformed feature point of the first image and its corresponding feature point of the second image can be measured according to the coordinate system of the second image. If the spatial distance exceeds a predetermined threshold, the system 100 regards it as mismatched feature point and discards it from the group of matched feature points. Secondly, coordinates of the feature points of the second image can be transformed from the coordinate system of the second image to that of the first image, according to the camera motion. Then a spatial distance between each transformed feature point of the second image and its corresponding feature point of the first image can be measured according to the coordinate system of the first image. If the spatial distance exceeds a predetermined threshold, the system 100 regards it as the mismatched feature point and discards it from the group of matched feature points. The remaining feature points of spatial distance less than the predetermined threshold can then be used to participate in the matrix transformation. Finally, the transform matrix can be computed according to at least four of the remaining correct feature points by means of RANSAC (Random Sample Consensus), BruteForce, SVD (Singular Value Decomposition), and other prior-art computational methods of matrix transformation.

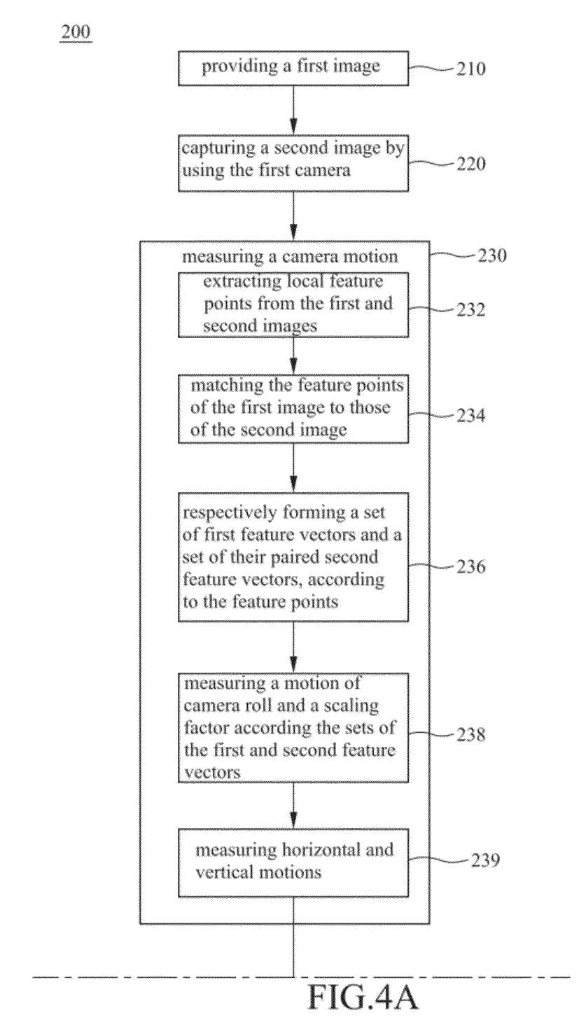

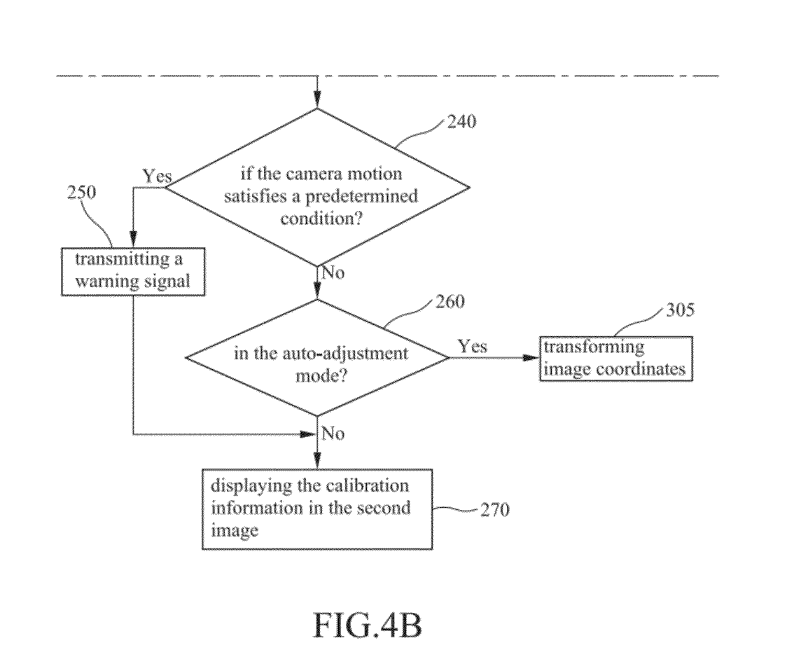

Please refer to FIG. 4, which is a flow chart of a recalibration method 200 for a to-be-recalibrated camera (hereafter, referred as “first camera”) according to a second embodiment of the present disclosure. According to FIGS. 1 and 4, the recalibration method 200 includes the following steps. In Step 210, a first image is provided. In Step 220, an image is captured by using the first camera 110 as a second image. In Step 230, a camera motion between the first and second images is measured, and calibration information corresponding to the camera motion is computed. The camera motion includes a motion magnitude and a motion direction, and the calibration information includes a calibration magnitude equal to the motion magnitude and a calibration direction opposed to the motion direction. And in Step 270, the calibration information is displayed in the second image.

According to Step 210, the first image can be an image captured by the first camera 110 being originally setup, an image captured by a second camera 110-1 being originally setup, or an image at a predetermined location captured by any camera. The first image serves as a reference image for the calibration of the first camera 110. According to Step 220, the second image is the image captured by the first camera 110. Here, the recalibration of camera and the capturing of image have been described in the first embodiment and hence is not going to be restated in detail.

According to Step 230, the measuring step of the camera motion between the first and second images can be divided into the following sub-steps. In Step 232, local feature points can be extracted from the first and second images. In Step 234, feature points matching are performed between the first image and the second image. In Step 236, a set of first feature vectors and a set of their paired second feature vectors are formed respectively, wherein each first feature vector is formed by connecting a feature point to another feature point in the first image, and each second feature vector is formed by connecting the corresponding matched feature points in the second image. In Step 238, the camera motion including a motion of camera roll and a scaling factor can be measured according the sets of the first and second feature vectors. And in Step 239, horizontal and vertical motions can be computed accordingly.

To detect and extract the local image features, a lot of prior-art methods such as SIFT, SURF, LBP, or MSER can be applied to the present embodiment. After the local feature points are extracted, the feature points matching in the first and second images are performed, so as to estimate various motion diversions for first camera 110. The motion of camera roll can be measured by a central tendency of a data set which is composed of motion of camera yaw and camera pitch between a plurality of first feature vectors and their paired second feature vectors, wherein each first feature vector is formed by connecting a feature point to another feature point in the first image, each second feature vector is formed by connecting a feature point to another feature point in the second image, and each feature point extracted from the first image corresponds to each feature point extracted from the second image. The statistical measure of central tendency is selected and computed from a group consisting of arithmetic mean, the median, the mode, and the histogram statistic. Regarding the histogram statistic, for example, a data set is classified into multiple groups according to a predetermined value, then a histogram is formed of the statistical distribution of the groups, and finally the histogram statistic can be measured by the arithmetic mean of the bin of the highest tabular frequency and the at least one right-side and left-side nearest neighbor bins. Similarly, the scaling factor can be measured by a central tendency of a data set which is composed of ratios of length of a plurality of the first feature vectors to their paired second feature vectors, wherein each first feature vector is formed by connecting a feature point to another feature point in the first image, each second feature vector is formed by connecting a feature point to another feature point in the second image, and each feature point extracted from the first image corresponds to each feature point extracted from the second image.

Furthermore, the first image is rotated in accordance with the motion of camera roll of the second image and scaled in accordance with the scaling factor of the second image to form a third image. Then the feature points of the third image can be extracted in correspondence with the feature points in the first and second images. The horizontal motion is measured by a central tendency of a data set which is composed of horizontal movements between feature points of the third image and their matched feature points of the second image in horizontal, and the vertical motion is measured by a central tendency of a data set which is composed of vertical movements between feature points of the third image and their matched feature points of the second image. On the other hand, the second image can also be rotated in accordance with the motion of camera roll of the first image and scaled in accordance with the scaling factor of the first image to form a fourth image. Then the feature points of the fourth image can be extracted in correspondence with the feature points in the first and second images. The horizontal motion can be measured by a central tendency of a data set which is composed of horizontal movements between feature points of the fourth image and their matched feature points of the first image, and the vertical motion can be measured by a central tendency of a data set which is composed of vertical movements between feature points of the fourth image and their matched feature points of the first image. Also regarding the histogram statistic, a data set is classified into multiple groups according to a predetermined value, then a histogram is formed of the statistical distribution of the groups, and finally the histogram statistic can be measured by the arithmetic mean of the bin of the highest tabular frequency and the at least one right-side and left-side nearest neighbor bins.

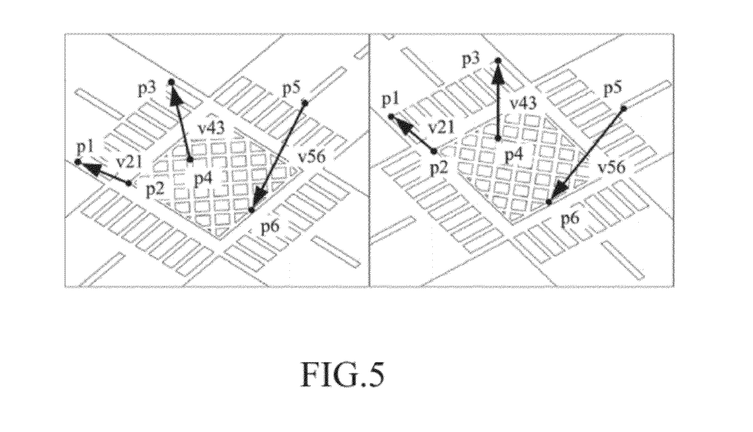

In an exemplary embodiment as shown in FIG. 5, n feature vectors can be selected arbitrarily from the two images, the first image and the second image. The feature vectors, denoted by v₂₁, v₄₃, and v₅₆ in FIG. 5, are formed by connecting any two feature points (for example, p₁ to p₆) in the first image, and the corresponding matched feature points in the second image. The feature vectors can be denoted generally by v̅_{b,i}=(x, y), i=1, 2, . . . , n and v̅_{t,i}=(x, y), i=1, 2, . . . , n for the first and second images, respectively, wherein the subscript b represents the first image or the reference image of recalibration, while the subscript t represents the second image captured by the to-be-recalibrated camera. The v̅_{b,i} and v̅_{t,i} of Cartesian coordinate system can be respectively transformed into (r_{b,i}, θ_{b,i}) and (r_{t,i}, θ_{t,i}) of the polar coordinate systems. For each corresponding pair of v̅_{b,i} and v̅_{t,i}, the angle between the two feature vectors can be computed with Δθᵢ=θ_{t,i}−θ_{b,i}, i=1, 2, . . . , n. The whole angle of 2π can be divided into 36 groups with a bin size of 10 degrees, and then a histogram is formed of the statistical distribution of the groups. The histogram statistic of motion of camera roll φᵣₒₗₗ can be measured by the arithmetic mean of the bin of the highest tabular frequency and the at least one right-side and left-side nearest neighbor bins.

Regarding the scaling factor, the ratios between lengths of the two feature vectors can be represented by

$${s}_{i} = \frac{{r}_{t , i}}{{r}_{b , i}} , i = 1 , 2 , … , n .$$

The whole quantity range of the ratios can be divided into a plurality of groups with a bin size of 0.1, and then a histogram is formed of the statistical distribution of the groups. The histogram statistic of scaling factor s_{zoom} can be measured by the arithmetic mean of the bin of the highest tabular frequency and the at least one right-side and left-side nearest neighbor bins. The image may have been scaled down with a scaling factor less than 1, while the image may have been scaled up with a scaling factor more than 1.

Regarding the motions in horizontal and vertical, the first and second images can be transformed so as to be in the same reference angle. For example, the first image can be rotated by a phase angle φᵣₒₗₗ with its central point translated to the origin of the coordinate system. Thus each pixel translation of the first image is mapped to the Cartesian coordinates by

$${p}_{b , i}^{′} = ( {x}^{′} , {y}^{′} ) = ( x - \frac{h}{2} , y - \frac{w}{2} ) , i = 1 , 2 , … , l ,$$

and then transformed into its polar coordinates with rotation of the phase angle φᵣₒₗₗ:

$${r}_{b , i}^{′} = \sqrt{{x}^{′2} + {y}^{′2}} , i = 1 , 2 , … , l$$

$${x}^{″} = {s}_{zoom} \cdot {r}_{b , i}^{′} \cdot cos ( {θ}_{b , i}^{′} + {φ}_{roll} ) + \frac{h}{2}$$

$${y}^{″} = {s}_{zoom} \cdot {r}_{b , i}^{′} \cdot sin ( {θ}_{b , i}^{′} + {φ}_{roll} ) + \frac{w}{2}$$

$$wherein$$

$${θ}_{b , i}^{′} = \{ \begin{matrix}{tan}^{- 1} \vert {y}^{′} \vert / \vert {x}^{′} \vert , & if {x}^{′} \geq 0 and {y}^{′} \geq 0 \\ π - {tan}^{- 1} \vert {y}^{′} \vert / \vert {x}^{′} \vert , & if {x}^{′} < 0 and {y}^{′} \geq 0 \\ π + {tan}^{- 1} \vert {y}^{′} \vert / \vert {x}^{′} \vert , & if {x}^{′} < 0 and {y}^{′} < 0 \\ - {tan}^{- 1} \vert {y}^{′} \vert / \vert {x}^{′} \vert & if {x}^{′} \geq 0 and {y}^{′} < 0 ,\end{matrix} \\ i = 1 , 2 , … , l$$

After the rotation, the coordinates of each pixel become p_{b,i}″=(x″, y″), i=1, 2, . . . , l, and then the horizontal and vertical motions can be expressed as

mᵢ=p_{t,i}−p_{b,i}″=(Δxᵢ,Δyᵢ)=(x_{t,i}−x″,y_{t,i}−y″),i=1, 2, . . . , l

wherein Δxᵢ and Δyᵢ respectively denote the motions in the horizontal and vertical directions for each corresponding pair of feature points. The Δxᵢ and Δyᵢ can be divided into a plurality of groups with a bin size of 10 pixels, and then a histogram is formed of the statistical distribution of the groups. The histogram statistic of the horizontal and vertical motions can be respectively measured by the arithmetic mean of the bin of the highest tabular frequency and the at least one right-side and left-side nearest neighbor bins. After all, in a spherical camera model, the camera pitch angle can be

$${φ}_{pitch} ≅ {θ}_{v} \cdot \frac{Δ x}{h}$$

and the camera yaw angle can be

$${φ}_{yaw} ≅ {θ}_{h} \cdot \frac{Δ y}{w} ,$$

wherein θᵥ is the vertical view angle of the camera, θₕ is the horizontal view angle, h is the image pixel in the vertical direction, and w is the image pixel in the horizontal direction.

In Step 270, corresponding to the camera motion in Steps 238 and 239, the camera motion can be represented in a form of prompt sign, which can be referred to the foregoing descriptions of prompt sign in the first embodiment. In Step 240, the camera motion is checked to see whether it satisfies a predetermined condition. For example, if the measured camera motion such as the motion magnitude or motion direction of the first camera 110 exceeds a predetermined threshold, a warning signal can be transmitted in Step 250; otherwise, it will be checked further if the first camera 110 is set in an auto-adjustment mode. If the first camera 110 operates in the auto-adjustment mode, the transformation of image coordinate can be performed as in Step 305; otherwise, in Step 270, the second image captured by the first camera 110 can be displayed on a display monitor 130 in real time, and the calibration information corresponding to the camera motion can also be shown in the second image, so as to provide on-site operators with more detailed information.

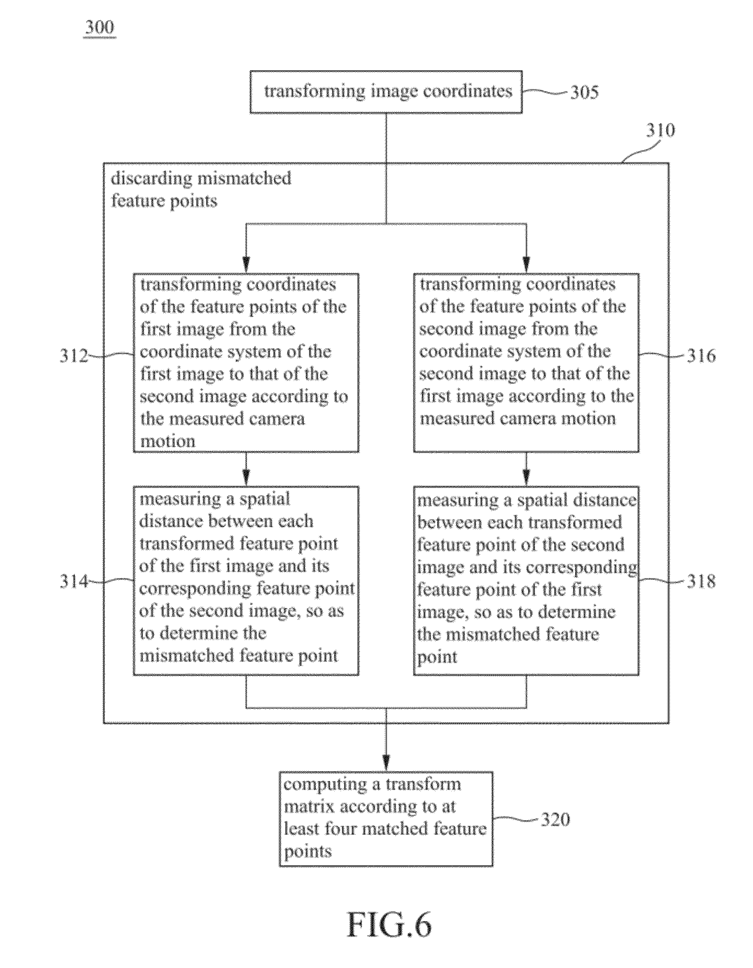

FIG. 6 shows a flowchart 300 of the transformation of image coordinate, which includes the following steps. In Step 310, mismatched feature points are discarded from the group of feature points. In Step 320, the transform matrix can be computed according to at least four of the remaining matched feature points by means of RANSAC, BruteForce, SVD, and other prior-art computational methods of matrix transformation. To discard the mismatched feature points, two alternative ways can be used in Step 310. In the first way, coordinates of the feature points are transformed in Step 312; that is to say, coordinates of the feature points of the first image can be transformed from the coordinate system of the first image to that of the second image according to the camera motion measured in Step 230. In Step 314, a spatial distance between each transformed feature point of the first image and its corresponding feature point of the second image can be measured, according to the coordinate system of the second image. If the spatial distance exceeds a predetermined threshold, the feature point is regarded as a mismatched feature point. In the other way, coordinate of the feature points are transformed in Step 316; that is to say, coordinates of the feature points of the second image can be transformed from the coordinate system of the second image to that of the first image according to the camera motion measured in Step 230. In Step 318, a spatial distance between each transformed feature point of the second image and its corresponding feature point of the first image can be measured, according to the coordinate system of the first image. If the spatial distance exceeds a predetermined threshold, the feature point is regarded as a mismatched feature point.

In an exemplary embodiment, the image coordinate of the foregoing first image is transformed according to the measured camera motion including a motion of camera roll and a scaling factor. A difference err, between each corresponding pair of feature points can be computed by the equation:

errᵢ=\sqrt{(x_{t,i}−x_{b,i}′)²+(y_{t,i}−y_{b,i}′)²},i1, 2, . . . , l

If the difference err, exceeds a predetermined threshold Tₑᵣᵣₒᵣ, the matched feature points will be regarded as mismatched feature points and discarded from the group of matched feature points. The matched feature points with their difference errᵢ not exceeding the threshold Tₑᵣᵣₒᵣ can then be kept in the group of matched feature points to participate in the matrix transformation.

The foregoing method of recalibrating a camera can be implemented in a form of computer program product, which is composed of instructions. Preferably, the instructions can be downloaded to a computer system to perform the recalibration method, whereby the computer system can function as the camera recalibration system.

Further, the computer program product can be stored in a computer readable medium, which can be any type of data storage device, such as an ROM (Read-Only Memory), an RAM (Random-Access Memory), a CD-ROM, a magnetic tape, a soft disk, an optical data storage device, or a carrier (for example, data transmission through the Internet). The computer program may perform the foregoing method of recalibrating a camera, after being downloaded to a computer system.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. A camera recalibration system comprising:
a first camera, which is to be recalibrated, for capturing image;
an image processing unit comprising
a storage unit for storing at least two images, a first image and a second image, the first image being as a reference image for recalibration, the second image being captured by the first camera; and
a computing unit for measuring a camera motion from the first image to the second image and computing calibration information corresponding to the camera motion; and
a display unit for presenting the calibration information.

2. The camera recalibration system of claim 1, wherein the image processing unit is selected from a group consisting of a PDA, an MID, a smart phone, a laptop computer, and a portable multimedia device.

3. The camera recalibration system of claim 1, wherein the calibration information is attached to the second image.

4. The camera recalibration system of claim 1, wherein the first image is selected from an image captured by the first camera being originally set up, an image captured by a second camera being originally set up, and an image at a predetermined location captured by any camera.

5. The camera recalibration system of claim 1, wherein the display unit further displays a real-time image captured by the first camera.

6. The camera recalibration system of claim 1, wherein the camera motion comprises a motion of camera roll, a scaling factor, or horizontal and vertical motions between the first and second images.

7. The camera recalibration system of claim 6, wherein the motion of camera roll is measured by a central tendency of a data set which is composed of motion of camera yaw and camera pitch between a plurality of first feature vectors and their paired second feature vectors, wherein each first feature vector is formed by connecting a feature point to another feature point in the first image, each second feature vector is formed by connecting a feature point to another feature point in the second image, and each feature point extracted from the first image corresponds to each feature point extracted from the second image.

8. The camera recalibration system of claim 6, wherein the scaling factor is measured by a central tendency of a data set which is composed of ratios of length of a plurality of the first feature vectors to their paired second feature vectors, wherein each first feature vector is formed by connecting a feature point to another feature point in the first image, each second feature vector is formed by connecting a feature point to another feature point in the second image, and each feature point extracted from the first image corresponds to each feature point extracted from the second image.

9. The camera recalibration system of claim 6, wherein the first image is transformed into a third image according to the motion of camera roll and the scaling factor of the second image, the horizontal motion is measured by a central tendency of a data set which is composed of horizontal movements between feature points of the third image and their matched feature points of the second image, and the vertical motion is measured by a central tendency of a data set which is composed of vertical movements between feature points of the third image and their matched feature points of the second image.

10. The camera recalibration system of claim 6, wherein the second image is transformed into a fourth image according to the motion of camera roll and the scaling factor of the first image, the horizontal motion is measured by a central tendency of a data set which is composed of horizontal movements between feature points of the fourth image and their matched feature points of the first image, and the vertical motion is measured by a central tendency of a data set which is composed of vertical movements between feature points of the fourth image and their matched feature points of the first image.

11. The camera recalibration system of claim 1, wherein the calibration information comprises a prompt sign, a prompt sound, or a prompt frequency.

12. The camera recalibration system of claim 11, wherein the prompt sign comprises a linear arrow, wherein length of the linear arrow indicates the magnitude by which the first camera is required to be calibrated, and arrowhead of the linear arrow indicates the direction by which the first camera is required to be calibrated.

13. The camera recalibration system of claim 11, wherein the prompt sign comprises an arced arrow, wherein length of the arced arrow indicates the magnitude by which the first camera is required to be calibrated, and arrowhead of the arced arrow indicates the direction by which the first camera is required to be calibrated.

14. The camera recalibration system of claim 11, wherein the prompt sign comprises a scaling sign, wherein a plus sign in an icon of the scaling sign indicates that the first camera needs to perform a zoom-in operation, while a minus sign indicates that the first camera needs to perform a zoom-out operation.

15. The camera recalibration system of claim 1, further comprising a control unit coupled to the image processing unit so as to provide a warning signal when the measured camera motion of the first camera satisfies a predetermined condition.

16. The camera recalibration system of claim 15, wherein the control unit is operable to perform transformation of image coordinate so as to transform the coordinate system of the second image to that of its original setting, if the control unit is in an operational mode of auto-adjustment and the measured camera motion of the first camera does not satisfy the predetermined condition.

17. A method for recalibrating a first camera which is to be recalibrated, the method comprising the steps of:
providing a first image;
capturing a second image by using a first camera;
measuring a camera motion between the first and second images and computing calibration information corresponding to the camera motion; and
displaying the calibration information in the second image.

18. The method of claim 17, wherein the first image is selected from an image captured by the first camera being originally setup, an image captured by a second camera being originally setup, or an image at a predetermined location captured by any camera.

19. The method of claim 17, further comprising the step of:
displaying a real-time image captured by the first camera.

20. The method of claim 17, wherein the step of measuring the camera motion comprises the steps of:
extracting local feature points from the first and second images;
matching the feature points of the first image to those of the second image;
forming a set of first feature vectors and a set of their paired second feature vectors, respectively, wherein each first feature vector is formed by connecting a feature point to another feature point in the first image, and each second feature vector is formed by connecting the corresponding matched feature points in the second image; and
measuring the camera motion including a motion of camera roll and a scaling factor according the sets of the first and second feature vectors.

21. The method of claim 20, wherein the motion of camera roll can be measured by a central tendency of a data set which is composed of motion of camera yaw and camera pitch between a plurality of first feature vectors and their paired second feature vectors.

22. The method of claim 20, wherein the scaling factor is a central tendency measure of a data set which is composed of ratios of length of a plurality of the first feature vectors to their paired second feature vectors.

23. The method of claim 20, wherein the step of measuring the camera motion further comprises the steps of:
transforming the first image into a third image according to the motion of camera roll and the scaling factor of the second image;
extracting feature points from the third image in correspondence with the feature points in the first and second images; and
measuring a central tendency of a data set which is composed of horizontal movements between feature points of the third image and their matched feature points of the second image as a horizontal motion, and measuring a central tendency of a data set which is composed of vertical movements between feature points of the third image and their matched feature points of the second image as a vertical motion.

24. The method of claim 20, wherein the step of measuring the camera motion further comprises the steps of:
transforming the second image into a fourth image according to the motion of camera roll and the scaling factor of the first image;
extracting feature points from the fourth image in correspondence with the feature points in the first and second images; and
measuring a central tendency of a data set which is composed of horizontal movements between feature points of the fourth image and their matched feature points of the first image as a horizontal motion, and measuring a central tendency of a data set which is composed of vertical movements between feature points of the fourth image and their matched feature points of the first image as a vertical motion.

25. The method of claim 17, wherein the calibration information comprises a prompt sign, a prompt sound, or a prompt frequency.

26. The method of claim 25, wherein the prompt sign comprises a linear arrow, wherein length of the linear arrow indicates the magnitude by which the first camera is required to be calibrated, and arrowhead of the linear arrow indicates the direction by which the first camera is required to be calibrated.

27. The method of claim 25, wherein the prompt sign comprises an arced arrow, wherein length of the arced arrow indicates the magnitude by which the first camera is required to be calibrated, and arrowhead of the arced arrow indicates the direction by which the first camera is required to be calibrated.

28. The method of claim 25, wherein the prompt sign comprises a scaling sign, wherein a plus sign in an icon of the scaling sign indicates that the first camera needs to perform a zoom-in operation, while a minus sign indicates that the first camera needs to perform a zoom-out operation.

29. The method of claim 17, further comprising the step of:
transmitting a warning signal when the camera motion satisfies a predetermined condition.

30. The method of claim 17, if the camera motion does not satisfy a predetermined condition, the method further comprising the steps of:
extracting local feature points from the first and second images, and matching the feature points of the first image to those of the second image;
transforming coordinates of the feature points of the first image from the coordinate system of the first image to that of the second image according to the measured camera motion, so as to perform coordinate transformation of the feature points;
measuring a spatial distance between each transformed feature point of the first image and its corresponding feature point of the second image, according to the coordinate system of the second image;
if the spatial distance exceeds a predetermined threshold, then regarding the feature point as a mismatched feature point and discarding it from the group of feature points; and
computing a transform matrix according to at least four matched feature points in the group.

31. The method of claim 17, if the camera motion does not satisfy a predetermined condition, the method further comprising the steps of:
extracting local feature points from the first and second images, and matching the feature points of the first image to those of the second image;
transforming coordinates of the feature points of the second image from the coordinate system of the second image to that of the first image according to the measured camera motion, so as to perform coordinate transformation of the feature points;
measuring a spatial distance between each transformed feature point of the second image and its corresponding feature point of the first image, according to the coordinate system of the first image;
if the spatial distance exceeds a predetermined threshold, then regarding the feature point as a mismatched feature point and discarding it from the group of feature points; and
computing a transform matrix according to at least four matched feature points in the group.

32. A computer program product containing at least one instruction, the at least one instruction for being downloaded to a computer system to perform the method of claim 17.

33. A computer readable medium containing a computer program, the computer program performing the method of claim 17 after being downloaded to a computer system.
